(19) United States
(12) Patent Application Publication
(10) Pub. No.: US 2016/0034067 A1
(43) Pub. Date: Feb. 4, 2016

(54) MECHANICAL STRESS DETECTION DEVICE INCLUDING A CAPACITIVE SENSOR, SET OF DETECTION DEVICES AND TOUCH LOCALIZATION DEVICE INCLUDING CAPACITIVE SENSORS

(71) Applicant: COMMISSARIAT A L'ENERGIE ATOMIQUE ET AUX ENERGIES ALTERNATIVES, Paris (FR)

(72) Inventor: Nicolas GUENARD, Gif-sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 14/773,998

(22) PCT Filed: Mar. 6, 2014
(86) PCT No.: PCT/FR14/50513

§ 371 Date: Sep. 9, 2015

(30) Foreign Application Priority Data
Mar. 11, 2013 (FR) 1352147

(51) Int. Cl. G06F 3/044; G01L 1/14

(52) U.S. Cl. CPC G06F 3/044; G01L 1/146

(57) ABSTRACT

A mechanical stress detection device includes a capacitive sensor including a first electrode including a first main face, a second electrode including a second main face arranged facing the first main face of the first electrode, an elastic dielectric medium extending between the first main face of the first electrode and the second main face of the second electrode, a mechanism measuring a capacitance at terminals of the two electrodes, and a mechanism compensating mechanical stress in which a fixed part is rigidly connected to one of the first and second electrodes and a movable part relative to the fixed part including an adjustable counterweight is rigidly connected to the other of the first and second electrodes.

The present invention relates to a mechanical stress detection device including a capacitive sensor. It also relates to a set of stress detection devices including capacitive sensors and to a device for localizing touch on a touch-sensitive surface comprising such a set of detection devices.

One target application is the use of sensors for rendering any surface touch-sensitive, regardless of the material thereof (wood, glass, plastic, plaster, etc.) and regardless of the shape thereof (plane or in relief).

At the present time, the technologies used are essentially the deployment of a capacitive film on the surface to be rendered touch-sensitive or the installation of an infrared frame around this surface. In the first case, a plastic film wherein an electrical network connected to a computing unit is etched is extended on the surface. When touched with a finger, the capacitance measured is locally disturbed, making it possible to localize the touch. However, this technology impairs the transparency of the surface whereon the film meshed with electrical wires is deployed and the deployment of such a plastic film on a surface with relief may quickly prove to be problematic. In the second case, the frame consists of transmitting and receiving infrared light-emitting diodes arranged respectively facing one another horizontally and vertically so as to generate a grid pattern of the surface. When a finger or any other object breaks the horizontal and vertical beams, it is localized. However, this technology is very sensitive to sunlight, which is charged with infrared rays, and to the environment (dirt). Furthermore, the surface must be plane. Moreover, in both cases cited above, the cost price is high and rises rapidly according to the size of the surface to be rendered touch-sensitive.

A further solution is then that of arranging a number of mechanical stress detection devices against the surface to be rendered touch-sensitive independently of the size thereof and applying a method based on a measurement of the respective stresses applied on each detection device when touched to infer therefrom, by barycentric computation, the localization of the touch. Such a method is for example disclosed in the patent U.S. Pat. No. 3,657,475. At least two detection devices are required for one-dimensional localization of the touch with respect to an axis. At least three detection devices are required for two-dimensional localization, given that four detection devices arranged at the four corners of a rectangular surface make it possible to obtain satisfactory results with satisfactory overall stability.

The patent U.S. Pat. No. 3,657,475 describes four sensors inserted between a fixed supporting member and a touch-sensitive surface at the four corners thereof. These sensors are stress gauges or piezoelectric sensors. They must, on one hand, withstand the empty weight of the touch-sensitive surface and, on the other, remain sensitive to touches the force or pressure whereof are added to the weight of this touch-sensitive surface. The force of the touch thus cannot be too low with respect to the weight of the surface so as not to give rise to problems in respect of sensitivity and precision. Furthermore, the sensors used in this document are relatively costly and piezoelectric sensors in particular are sensitive to temperature variations. For these reasons, the invention relates more specifically to a mechanical stress detection device including a capacitive sensor.

In the patent U.S. Pat. No. 7,148,882 B2, a mechanical stress detection device including a capacitive sensor consisting of two electrodes held at a certain distance from one another is proposed. The capacitive sensor is positioned under the surface to be rendered touch-sensitive and is kept in contact therewith with a point connection rigidly connected to the upper electrode. Touching the surface causes the two electrodes to move closer, thus modifying the capacitance value. The elastic deformation of the upper electrode makes it possible to modify the capacitance in the event of touch and return the sensor to the initial position thereof when the touch is interrupted. The drawback of this sensor remains the vulnerability thereof with respect to the weight of the surface to be rendered touch-sensitive. Indeed, the greater the weight of the surface, the higher the stiffness constant of the upper electrode needs to be and the lower the sensitivity of the sensor to the forces generated by touch. One solution would then be to adjust the weight of the surface rendering the surface as light as possible to increase the sensitivity of the sensor. However, this solution is not satisfactory when one of the aims is that of being independent from the choice of the material to form the touch-sensitive surface.

In the patent EP 1 350 080 B1, a capacitive sensor including electrodes separated by a dielectric is also proposed, but this dielectric has the elasticity property enabling the sensor to return to an initial position in the absence of touch. As such, more specifically, the capacitive sensor proposed in this document comprises a first electrode having a first main face, a second electrode having a second main face arranged facing the first main face of the first electrode, an elastic dielectric medium extending between the first main face of the first electrode and the second main face of the second electrode, and means for measuring a capacitance at the terminals of the two electrodes. This capacitive sensor thus consists of a plane capacitor wherein the variable distance between the electrodes thereof renders the capacitance thereof variable as a function of the force or pressure applied against one of the two electrodes thereof. However, this sensor is used in the context of the document EP 1 350 080 B1 for weighing vehicles, i.e. in a context where the stress to be measured is considerably higher than the weight of the contact surface.

In the context of a touch-sensitive surface, such a sensor could pose problems in respect of sensitivity or precision such as those mentioned above. Indeed, in the absence of any touch applying stress on the touch-sensitive surface and thus on the sensor itself, the latter must nonetheless withstand a part of the empty weight of the touch-sensitive surface which is often not negligible with respect to the touches to be detected. This decreases the range of measurable values accordingly. The solution cited above consisting of reducing the weight of the touch-sensitive surface is obviously not satisfactory.

Furthermore, the stress measured by the capacitive sensor is normal to the surface thereof. It is thus dependent on the inclination which may vary significantly during use if the touch-sensitive surface against which the capacitive sensor is arranged changes inclination.

Finally, in the event of vibrations, inertial forces are generated altering the measurements supplied by the sensor.

It may thus be sought to provide a mechanical stress detection device including a capacitive sensor which is suitable for doing away with at least some of the problems and constraints cited above.

A mechanical stress detection device is then proposed including a capacitive sensor including:
a first electrode having a first main face,
a second electrode having a second main face arranged facing the first main face of the first electrode,
an elastic dielectric medium extending between the first main face of the first electrode and the second main face of the second electrode, and
means for measuring a capacitance at the terminals of the two electrodes, further including means for compensating mechanical stress wherein a fixed part is rigidly connected to one of said first and second electrodes and wherein a movable part relative to the fixed part provided with an adjustable counterweight is rigidly connected to the other of said first and second electrodes.

As such, the counterweight mechanism associated with one of the two electrodes of the capacitive sensor is suitable for compensating in an adjustable manner some of the mechanical stresses liable to be applied to this electrode. It is then particularly possible to compensate for the empty weight of a touch-sensitive surface against which the detection device including a capacitive sensor is intended to be arranged, such that this increases the touch-sensitivity thereof. However, furthermore, such a mechanism also protects the sensor against vibrations or changes of inclination also enhancing the precision of the measurements thereof.

Optionally, the movable part is movable in rotation about a shaft of the fixed part and includes:
a first balance beam arm portion wherein one end is intended to be in contact with a touch-sensitive surface, and
a second counterweight arm portion comprising the adjustable counterweight, this second arm portion extending on the other side of the shaft of the first part relative to the first arm portion.

Also optionally, the adjustable counterweight includes:
a rod wherein a part has a screw thread,
a mass attached to this rod by a helical link, and
a setting tip suitable, by rotatably actuating the rod about the axis thereof, for moving the mass along the rod so as to move it closer to or further from the shaft of the fixed part by sliding.

Also optionally, the setting tip includes a controlled motor.

Also optionally, the elastic dielectric material includes silicone or polyurethane.

Also optionally, the two electrodes are cylindrical, have circular cross-sections and are arranged coaxially relative to one another, the two main faces facing one another being plane.

Also optionally, a mechanical stress detection device according to the invention may further include means for estimating a stress applied against one of the two electrodes on the basis of the capacitance measured.

A set of mechanical stress detection devices is further proposed, including:
a plurality of mechanical stress detection devices according to the invention,
an electronic module for processing signals from this plurality of detection devices, and
wired or wireless means for transmitting signals from each of the detection devices to the electronic signal processing module.

A device for localizing touch on a touch-sensitive surface is further proposed including:
a set of mechanical detection devices according to the invention,
a touch-sensitive surface against which the detection devices of said set are arranged, the movable parts of the compensation means thereof being in contact with the touch-sensitive surface, and
means for localizing touch on the touch-sensitive surface by processing, using the electronic module of said set, stresses estimated using the signals supplied by the detection devices.

Optionally, the touch-sensitive surface includes a strip wherein activatable light sources are distributed linearly, the device including:
one detection device arranged at each end of the strip, and
means for selecting a light source on the basis of a touch localization.

The invention will be understood more clearly using the description hereinafter, given merely by way of example and with reference to the appended figures wherein:

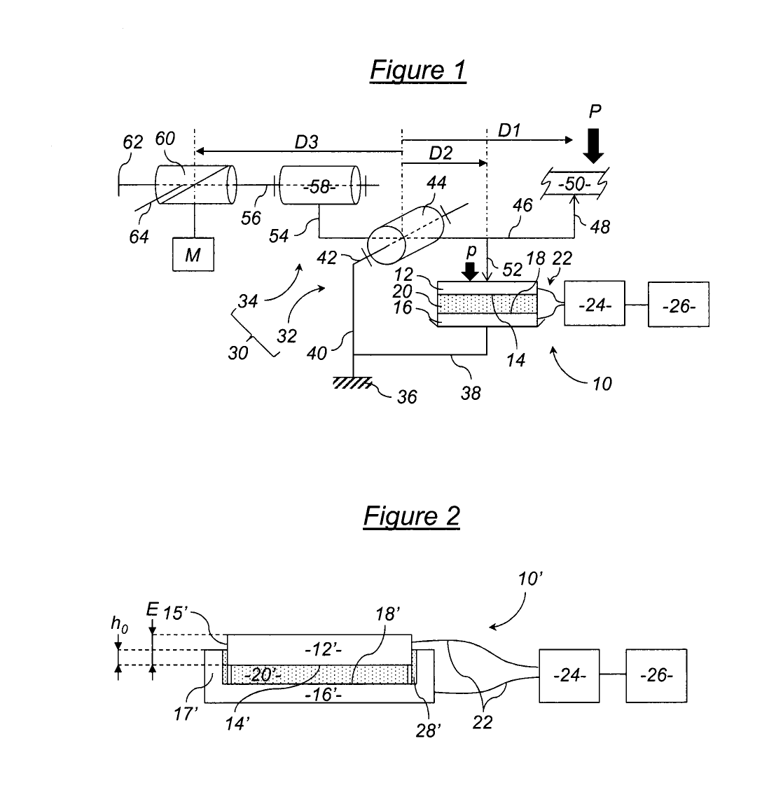

FIG. 1 represents schematically and in a cross-sectional view the general structure of a mechanical stress detection device, according to one embodiment of the invention,

FIG. 2 represents schematically and in a cross-sectional view the general structure of an alternative embodiment of a capacitive sensor of the detection device in FIG. 1,

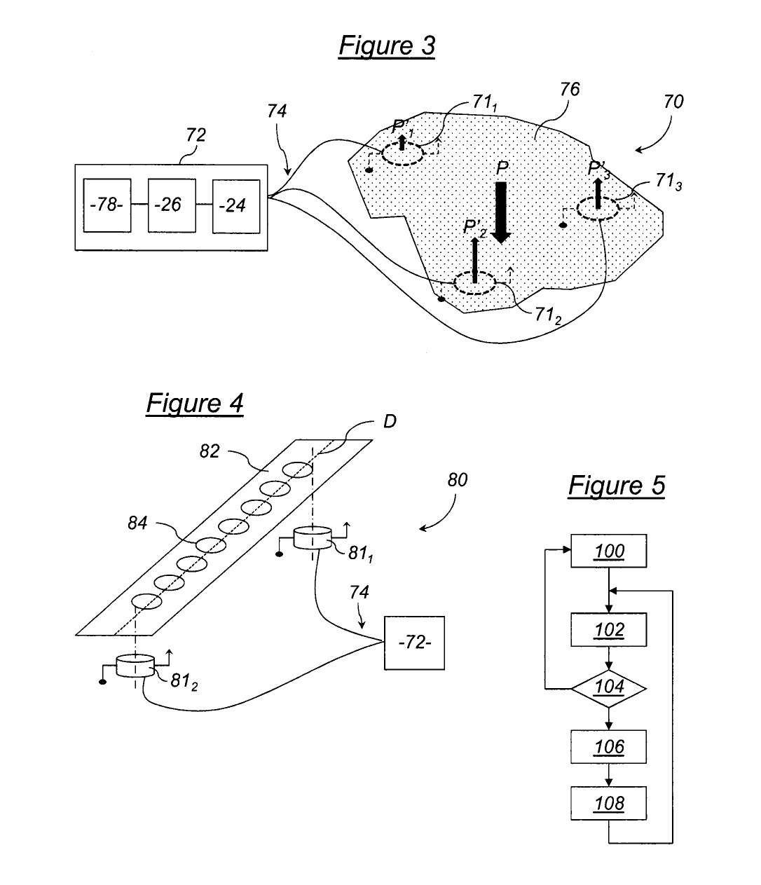

FIG. 3 represents schematically the general structure of a device for localizing touch on a touch-sensitive surface, according to a first embodiment of the invention,

FIG. 4 represents schematically the general structure of a device for localizing touch on a touch-sensitive surface, according to a second embodiment of the invention, and

FIG. 5 illustrates the successive steps of a method for localizing touch implemented by either of the devices in FIGS. 3 and 4.

The mechanical stress detection device represented schematically in FIG. 1 includes a capacitive sensor 10 comprising a first electrode 12 having a first main face 14. It includes a second electrode 16 having a second main face 18 arranged facing the first main face 14 of the first electrode 12. It includes an elastic dielectric medium 20, for example silicone or polyurethane, extending between the first main face 14 of the first electrode 12 and the second main face 18 of the second electrode 16. This elastic dielectric medium 20 essentially fulfils two functions. The first is that of insulating the two main faces 14 and 18 facing one another. The second is that of forming return means which are compressed when a stress is applied against one of the two electrodes and restore an initial idle position in the absence of stress. Finally, the capacitive sensor 10 includes means 22, 24 for measuring a capacitance at the terminals of the two electrodes 12 and 16. These means 22, 24 include at least two conductors 22 at the terminals whereof a capacitance can be measured using a possible impedance measurement device 24.

In concrete terms, the two electrodes 12 and 16 may have a cylindrical general shape. More specifically, for the purposes of simplifying manufacture, the two cylindrical electrodes 12 and 16 have circular cross-sections and are arranged coaxially in relation to one another, the two main faces 14 and 18 facing one another being plane.

When a stress is applied to any of the free faces of the two electrodes, for example that of the first electrode 12, due to the elasticity of the dielectric medium 20, the two main faces 14 and 18 facing one another move closer together. As such, the capacitive sensor 10 acts as a variable-capacitance plane capacitor.

This variable capacitance may be annotated as follows:

$$C = f ( d ) = {ɛ}_{1} \frac{A}{d} ,$$

where ε₁ represents the permittivity of the dielectric medium 20, A the common surface area of the two main faces 14 and 18 facing one another and d the distance separating same, the latter being variable on the basis of the stress applied on the first electrode 12.

As such, if the two electrodes 12 and 16 move closer under the effect of stress, d decreases thus C increases. On the other hand, if the two electrodes 12 and 16 move away from one another under the effect of an elastic return to an idle position of the capacitive sensor 10 when the stress has disappeared, d increases thus C decreases.

In practice, it is noted that the distance d₀ corresponding to the idle position of the capacitive sensor 10 should be sufficiently small so as to have a sufficiently high capacitance, even when idle, to be measurable by the measurement device 24 (in the region of 10 pF) and so as to have the greatest possible variation when the two electrodes 12 and 16 are brought slightly closer together.

In practice also, so that the stress applied against the electrode 12 generates a sufficient force or pressure against the capacitive sensor 10, the common surface area A of the two main faces 14 and 18 facing one another should be limited.

In practice also, it is noted that the variation of C is not linear on the basis of the variation of d. This must be taken into account to render the response of the capacitive sensor 10 as linear as possible.

In practice also, on the basis of the elastic dielectric medium 20 chosen, the maximum compression thereof is limited and it is necessary to associate, with the preceding relation C=f(d) between the variation of distance d and the variation of capacitance C, the relation d=g(p) between a stress p applied against the electrode 12 and the inherent deformation of the material used, defined by the variable d, to determine the actual relation C=fog(p) between this stress applied p and the capacitance C measured at the terminals of the capacitive sensor 10. Once this relation fog is known, it is possible to implement the inversion thereof in the form of a stress computer 26, for example connected to the measurement device 24, thus fulfilling a function for estimating a stress p, force or pressure, applied against one of the two electrodes 12 and 16 on the basis of the capacitance C measured.

It should be noted that the measurement device 24 and the stress computer 26 are only optionally part of the capacitive sensor 10, and more generally of the detection device. They may indeed be offset in separate computing means.

It should finally be noted that the cost of manufacture of such a capacitive sensor 10 is derisory. However, on the basis of the features thereof, a compromise is to be made between the measurement scale to be attained and the precision required. It is indeed difficult to manufacture a sensor at a low cost having both a wide measurement scale and a very good precision. By way of example and expressing the stress in terms of mass, it is difficult for such a sensor to have a measurement scale ranging from 0 to 1 kg while applying a sensitivity of within one gram.

The mechanical stress detection device represented schematically in FIG. 1 further includes means 30 for compensating mechanical stress wherein a fixed part 32 is rigidly connected to one of said first and second electrodes and wherein a movable part 34 relative to the fixed part 32 provided with an adjustable counterweight is rigidly connected to the other of said first and second electrodes. More specifically, in this example, the second electrode 16 is fixed and rigidly connected to the first part 32 of the compensation means 30 whereas the first electrode 12 is movable and rigidly connected to the movable part 34 of the compensation means 30.

The fixed part 32 is rigidly connected to a frame 36. It schematically includes a first arm 38 bearing the second electrode 16 to which it is attached and a second arm 40 bearing the movable part 34, said part only being free in rotation along the axis of a shaft 42 ending the second bearing arm 40. This freedom of movement of the movable part 34 in rotation only about the shaft 42 without possible translation along this shaft is symbolized by the element 44.

The movable part 34 includes a balance beam arm portion 46 extending from the axis of the shaft 42 to a bearing point end 48 against a touch-sensitive surface 50. This bearing point 48 is at a distance D1 from the axis of the shaft 42. The first arm portion 46 also includes an attachment point 52 to the first electrode 12 of the capacitive sensor 10. This attachment point 52 is at a distance D2 from the axis of the shaft 42, D2 being less than D1. As such, the contribution P of a stress applied against the surface 50 at the bearing point 48 is transmitted by means of a balance beam effect in the form of pressure or force p by the attachment point 52 to the first electrode 12 which moves closer to the second electrode 16 by compressing the elastic dielectric medium 20.

The movable part 34 includes a second counterweight arm portion 54 extending on the other side of the shaft 42 relative to the first balance beam arm portion 46. This second arm portion 54 bears a rod 56 free in rotation about the longitudinal axis thereof, this freedom in rotation being symbolized by the element 58. The rod 56 includes a part having a screw thread to which a mass M is attached by a helical link (symbolized by the element 60). One of the ends of the rod 56 is equipped with a manual setting tip 62 for moving by rotating the rod 56 about the axis thereof, further by means of a rotation stopping mechanism 64, the mass M along the rod 56 so as to move it closer to or further from the shaft 42 by sliding. The mass M is thus at a variable and adjustable distance D3 from the axis of the shaft 42.

As such, by adjusting the position of the mass M along the rod 56, it is for example possible to compensate the effect of the empty weight of the touch-sensitive surface 50 on the first electrode 12. In this way, in the absence of touch on the touch-sensitive surface 50, no stress is applied on the capacitive sensor 10. The scale of the measurements that can be made by this sensor is thus used fully for the detection of a touch applying a stress P on the touch-sensitive surface 50, which enhances the precision thereof.

Optionally, abutments may be placed on the first balance beam arm portion 46 so as to protect the capacitive sensor 10 against excessive pressure applied on the touch-sensitive surface 50.

Alternatively, the manual setting tip 62 could be replaced by a motorized setting tip using a controlled motor. This would be particularly advantageous in an application where it is sought to automatically calibrate the touch-sensitive surface 50 when said surface may vary in weight (for example for the touch-sensitivity of a table whereon objects may be placed or removed).

Also alternatively, the capacitive sensor 10 could be arranged on the other side of the shaft 42, i.e. on the side of the counterweight. As such, it would no longer be touch-sensitive under pressure but under traction.

If the empty mass of the touch-sensitive surface 50 supported by the detection device in FIG. 1 at the bearing point 48 thereof is annotated as m, said mass is completely compensated by the counterweight mass M if the following relation is true:

m.g.D1=M.g.D3,

where g is the gravitational constant, i.e.:

$$D 3 = D 1 \cdot \frac{m}{M} .$$

In this configuration, the capacitive sensor 10 is in the idle position in the absence of touch and does not measure any stress.

When touched, if the stress applied thereby results in a force P at the bearing point 48, if the sum of the torques generated on the axis of the shaft 42 is annotated as Cₚ, this gives:

Cₚ=m.g.D1+P.D1−M.g.D3=P.D1,

in the light of the preceding relation.

This torque Cₚ is passed onto the capacitive sensor 10 such that the resulting force p applied against the first electrode means that the following relation is true:

$$p = \frac{{C}_{p}}{D 2} = P \cdot \frac{D 1}{D 2} .$$

In the light of all these relations, to increase the sensitivity of the capacitive sensor 10, it is advantageous to choose D1 and D2 such that D1-D2, and to limit the size of the mass M, it is advantageous to choose D1 and D3 such that D3>>D1. This results in the following advantageous relation: D2<<D1<<D3.

With respect to the influence of vibrations on the equilibrium of the forces applied to the detection device, these may be represented by an acceleration a, overlaid on the gravitational field g. As, furthermore, vibrations, as an inertial force, have no influence on the stress applied by touch on the touch-sensitive surface 50, this is considered to be zero. Hence, the sum Cₚ of the torques generated on the axis of the shaft 42 becomes:

Cₚ=m.(g+aᵥ).D1−M.(g+aᵥ).D3=(g+aᵥ).(m.D1−M.D3)=0.

This demonstrates that, using the compensation means 30, the vibrations do not disturb the measurements made by the capacitive sensor 10.

Similarly, it is demonstrated that, using the compensation means 30, a change of inclination of the touch-sensitive surface 50 likewise does not disturb the measurement of the capacitive sensor 10. Indeed, the mass M being subjected to the same inertial force as the touch-sensitive surface 50, the balance beam compensation means 30 naturally adapt to such a change of inclination.

In a further possible embodiment (not illustrated), the mass M could be replaced by an electro-magnet thus making it possible to avoid an additional lever arm. However, in this case, as the compensation force of the electro-magnet is not inertial in nature, vibrations or a change of inclination would disturb the measurement of the capacitive sensor 10. However, in practice, it is also possible to integrate a low-cost accelerometer rigidly connected to the frame 36 so as to optimally compensate for the inertial changes if the compensation relation previously introduced cannot be perfectly adhered to.

Moreover, to limit the weight of the touch-sensitive surface 50 on the detection device in FIG. 1, it is also possible to increase the number of such detectors so as to reduce the portage thereof.

A further capacitive sensor 10′ will now be detailed, which may replace the capacitive sensor 10 in the detection device in FIG. 1. This further capacitive sensor 10′, illustrated in a sectional view in FIG. 2, includes a first electrode 12′ having a first main face 14′ and an edge 15′ of a certain thickness E. It includes a second electrode 16′ having a second main face 18′ arranged facing the first main face 14′ of the first electrode 12′. It includes an elastic dielectric medium 20′, for example silicone or polyurethane, extending between the first main face 14′ of the first electrode 12′ and the second main face 18′ of the second electrode 16′. This elastic dielectric medium 20′ fulfils the same functions as the elastic dielectric medium 20. Finally, the capacitive sensor 10′ includes the same measurement means 22, 24 as the capacitive sensor 10.

The capacitive sensor 10′ is distinguished from the preceding one in that the second electrode 16′ further has a rim 17′ extending on the periphery of the second main face 18′ thereof about the edge 15′ of the first electrode 12′ merely on a part h₀ of the thickness E thereof when the elastic dielectric medium 20′ is in the idle position, i.e. when no temporary stress applies force or pressure against one of the two electrodes. In this idle position of the elastic dielectric medium 20′, the first and second main faces 14′ and 18′ of the two electrodes 12′ and 16′ are at an equilibrium distance d₀ from one another. Moreover, a guide 28′ made of dielectric material, for example ceramics, is advantageously inserted between the edge 15′ of the first electrode 12′ and the rim 17′ of the second electrode 16′ to fulfill an electrical insulator function.

In concrete terms, the two electrodes 12′ and 16′ may have a cylindrical general shape, the second electrode 16′ having a recess wherein the first electrode 12′ is partially housed, i.e. up to a depth equal to h₀<E. More specifically, for the purposes of simplifying manufacture, the two cylindrical electrodes 12′ and 16′ have circular cross-sections and are arranged coaxially in relation to one another, the two main faces 14′ and 18′ facing one another being plane. In this case, the guide 28′ made of dielectric material is annular and covers the entire inner surface of the rim 17′ of the second electrode 16′. It is suitable for guiding the movement in translation of the first electrode 12′ relative to the second electrode 16′ along the common axis thereof under the effect of a stress.

When such a stress is applied on any of the free faces of the two electrodes, for example that of the first electrode 12′, due to the elasticity of the dielectric medium 20′, the two main faces 14′ and 18′ facing one another move closer together and the part of the thickness E of the first electrode 12′, about which the rim 17′ of the second electrode 16′ extends, increases (h>h₀). As such, the capacitive sensor 10′ acts as a parallel combination of two variable-capacitance capacitors, one plane, the other cylindrical, the plane contribution of this hybrid variable-capacitance sensor being provided by the two main faces 14′ and 18′ facing one another which move closer together and the cylindrical contribution being provided by the inner surface of the rim 17′ facing the edge 15′ which increases.

The plane contribution of the variable capacitive sensor 10′ may be annotated as follows:

$$C = {ɛ}_{1} \frac{A}{d} ,$$

where ε₁, A and d have the same meanings as in the preceding example.

The cylindrical contribution of the variable capacitive sensor 10′ may be annotated as follows:

$${C}_{2} = \frac{2 π \cdot {ɛ}_{2} \cdot h}{ln ( \frac{b}{a} )} ,$$

where ε₂ represents the permittivity of the guide 28′ made of dielectric material, a the radius of the first electrode 12′ (it forms the inner radius of the cylindrical capacitor), b the inner radius of the rim 17′ of the second electrode 16′ (it forms the outer radius of the cylindrical capacitor) and h the insertion depth of the first electrode 12′ in the second electrode 16′.

The total variable capacitance of the capacitive sensor 10′ then takes the following form:

$$C = {C}_{1} + {C}_{2} = {ɛ}_{1} \frac{A}{d} + \frac{2 π \cdot {ɛ}_{2} \cdot h}{ln ( \frac{b}{a} )} ,$$

It is noted that the distance d and the depth h are fully correlated variables. Indeed, the sum d+h is always equal to d₀+h₀. Thus if d decreases, h increases accordingly. As a result, the capacitance C is a function of the sole variable d according to the following expression:

$$C = {f}^{′} ( d ) = {ɛ}_{1} \frac{A}{d} + \frac{2 π \cdot {ɛ}_{2} \cdot ( {d}_{0} + {h}_{0} - d )}{ln ( \frac{b}{a} )} .$$

As such, if the two electrodes 12′ and 16′ move closer together under the effect of a stress, d decreases, thus C₁ and C₂ increase together such that C increases all the more. On the contrary, if the two electrodes 12′ and 16′ move away from each other under the effect of an elastic return to the idle position when the stress has disappeared, d increases thus C1 and C2 decrease together such that C decreases all the more. The sensitivity of the capacitive sensor 10′, rendered hybrid by the special conformation of the second electrode 16′ thereof wherein the rim 17′ partially surrounds the edge 15′ of the first electrode 12′, is thus enhanced in relation to that of the capacitive sensor 10.

In practice, it is observed that while the variation of C₂ is indeed linear on the basis of the variation of d and h, this is not always the case of that of C₁. This should be taken into account to render the response of the capacitive sensor 10′ as linear as possible.

In practice also, it is necessary to associate, with the preceding relation C=f′(d), the relation d=g(p) between the stress p applied against the electrode 12′ and the inherent deformation of the dielectric material 20′ used, defined by the variable d, to determine the actual relation C=f′og(p) between this stress applied p and the capacitance C measured at the terminals of the capacitive sensor 10′. Once this relation f′og is known, it is possible to implement the inversion thereof in the form of a stress computer 26.

It should also be noted in this example that the measurement device 24 and the stress computer 26 are only optionally part of the capacitive sensor 10′, and thus of the detection device. They may indeed be offset in separate computing means.

FIG. 3 illustrates the use of a plurality of detection devices such as that in FIG. 1 (with the capacitive sensor 10 in FIG. 1 or 10′ in FIG. 2) in a device 70 for localizing touch on a touch-sensitive surface, according to a first embodiment of the invention.

This device 70 firstly includes a set of detection devices including:
a plurality of detection devices such as that in FIG. 1, identified in FIG. 3 by the references 71₁, 71₂ and 71₃,
an electronic module 72 for processing signals from these detection devices 71₁, 71₂ and 71₃, and
wired or wireless means 74 for transmitting signals from each of the detection devices 71₁, 71₂ and 71₃ to the electronic signal processing module 72.

The device 70 for localizing touch further includes:
a touch-sensitive surface 76 against which the detection devices 71₁, 71₂ and 71₃ are arranged, the movable parts 34 of the compensation means 30 thereof, more specifically the bearing points 48 thereof, being in contact with the touch-sensitive surface, and
means 78 for localizing touch on the touch-sensitive surface 76 by processing, using the electronic module 72, stresses, forces or pressures, estimated using the signals supplied by the detection devices 71₁, 71₂ and 71₃.

In the example in FIG. 3, the touch-sensitive surface 76 has any shape and relief. It rests on a fixed supporting member.

Three detection devices 71₁, 71₂ and 71₃ are further envisaged, which corresponds to the minimum required to perform two-dimensional localization of touch on this touch-sensitive surface 76. Four detection devices are generally preferred. For example, if the touch-sensitive surface 76 is a plane rectangular table resting on a fixed supporting member consisting of four legs, one detection device may be envisaged at each corner of the table, more specifically inserted between the top of each leg and the bottom surface of the table. For each detection device, one of the electrodes rests on the fixed supporting member, for example the second electrode 16 or 16′, whereas the other electrode, for example the first electrode 12 or 12′ which is then movable in axial translation relative to the fixed electrode, is rigidly connected, via compensation means 30, to the touch-sensitive surface 76.

In the example in FIG. 3 also, it is proposed that the measurement device 24 and the stress computer 26 are offset from the detection devices to the electronic module 72, the transmission means 74 then consisting of conductors 22.

In practice, the electronic module 72 contains the electronic components suitable for carrying out the acquisition of the signals from the detection devices 71₁, 71₂ and 71₃, processing these signals by optionally merging same with further sensors (for example in the case wherein accelerometers are envisaged to compensate for any parasitic vibrations measured by the capacitive sensors), and communicating the result of this processing on a network or directly to another appliance, for applications relating to home automation and/or the control of appliances using a touch-sensitive surface. Low-cost components are available to carry out these well-known operations.

More specifically, the measurement device 24 includes for example a controller capable of processing up to 13 sensors to measure the capacitances thereof in parallel and converting same digitally into 16 bits. A low-pass averaging filter may also be activated to enhance the measurement precision. In 10 ms, four detection devices such as that illustrated by FIG. 1 may thus be processed and filtered. The capacitances measured and digitized by the device 24 are then made available to the stress computer 26 via a data transmission bus, SPI or I2C for example.

The stress computer 26 estimates, for each capacitance value from one of the detection devices 71₁, 71₂ and 71₃, a corresponding stress value applied to the device during touch, annotated as P in FIG. 3, applied on the touch-sensitive surface 76. The reactions to these stresses are annotated as P′₁, P′₂ and P′₃ respectively for the detection devices 71₁, 71₂ and 71₃ in FIG. 3. It is noted that the closer the touch is to one of the detection devices, the greater the stress applied thereon. The stress values (P₁, P₂, P₃) are then made available by the stress computer 26 to the localization means 78 via a data transmission bus, SPI or I2C for example.

The localization means 78 are designed to determine the localization of a touch detected using the stress values P₁, P₂, P₃ of the detection devices 71₁, 71₂ and 71₃. For this, they implement a method such as that disclosed in the patent U.S. Pat. No. 3,657,475, based on barycentric computation. This method will be detailed with reference to FIG. 5.

The stress computer 26 and the localization means 78 may for example be used in a computing device such as a conventional computer including a processor associated with one or a plurality of memories for storing data files and computer programs. The functions thereof may also be at least partially micro-programmed or micro-wired in dedicated integrated circuits. In particular, a 16-bit or 8-bit microcontroller capable of running a processing operation every 10 ms may suffice.

The device 70 for localizing touch using the touch-sensitive surface 76 may be used in different ways according to the target applications. In particular, in “absolute mode”, the absolute position of the touch on the touch-sensitive surface 76 is sought relative to a fixed reference point. An image may then be projected onto the touch-sensitive surface 76 enabling coupling between the touching action and the function to be carried out. In “relative mode”, the precise localization of the touch is not necessarily of interest, but the changes thereof over time, for the recognition of gestures or actions. Furthermore, the device 70 is sensitive to the stress amplitude applied by the touch, which makes it possible to obtain direct information on the amplitude of the force applied by the user. The latter may then constitute an additional input in high-level interpretation software processing the data supplied by the sensors.

FIG. 4 illustrates the use of a plurality of detection devices such as that in FIG. 1 (with the capacitive sensor 10 in FIG. 1 or 10′ in FIG. 2) in a device 80 for localizing touch on a touch-sensitive surface, according to a second embodiment of the invention.

The device 80 firstly includes a set of detection devices including:
two detection devices such as that in FIG. 1, identified in FIG. 4 by the references 81₁ and 81₂,
the electronic module 72 described above, and
wired or wireless means 74 for transmitting signals from each of the detection devices 81₁ and 81₂ to the electronic module 72.

The device 80 for localizing touch further includes a touch-sensitive surface 82 against which the detection devices 81₁ and 81₂ are arranged, the movable parts 34 of the compensation means 30 thereof, more specifically the bearing points 48 thereof, being in contact with the touch-sensitive surface 82.

In the example in FIG. 4, the touch-sensitive surface 82 is more specifically a strip having a main axis D along which activatable light sources 84, for example light-emitting diodes, are distributed linearly. The two detection devices 81₁ and 81₂ are arranged at both ends of this strip 82. Advantageously, in this embodiment, the electronic module 72 is programmed to select at least one of the light sources 84 from a touch localization determined by the localization means 78 thereof on the basis of the signals supplied by the two detection devices 81₁ and 81₂. For example, the light source closest to the localization detected of the touch is activated. It is noted that in this example the touch localization is one-dimensional, along the axis D, which explains why two detection devices arranged at both ends of the strip 82 are necessary and sufficient.

The localization method used by the means 78 will now be detailed with reference to FIG. 5.

During a first step 100 for initializing the detection devices, during which no touch is applied on the touch-sensitive surface, the capacitance C₀ of each detection device is recorded and represents the idle reference value of each thereof. For each detection device, the arrangement of the mass M thereof along the rod 56 thereof may further be adjusted to compensate completely for the empty weight of the touch-sensitive surface supported by this detection device.

During a subsequent thresholding step 102, the value Pt=ΣᵢPtᵢ, i.e. the sum of the stresses Ptᵢ detected by the set of detection device directly indicating the stress P applied by touch on the touch-sensitive surface, is compared to a threshold value Ps.

Then, during a step 104, if Pt<Ps, the stress measured is considered to be too low and may be associated with noise or the start of a drift. The method then returns to the step 100 to reset and/or adjust the detection devices on the basis of this measurement.

If Pt>Ps during the step 104, a touch P is considered to be detected on the touch-sensitive surface and the method goes to a step 106 for the barycentric estimation of the localization of this touch P.

If \vec{Pos(P)} is used to annotate the estimated localization of the touch and \vec{Pos(Xᵢ)} the localization of the detection device Xᵢ (Xᵢ=71ᵢ or 81ᵢ), the barycentric estimation step 106 consists of making the following calculation:

$$\vec{Pos ( P )} = \frac{1}{Pt} \cdot {\sum }_{i} {Pt}_{i} \cdot \vec{Pos ( {X}_{i} )} .$$

It should be noted that the position of the detection devices may be obtained during a prior calibration step during which, for example, successive touches are applied at predetermined and known locations on the touch-sensitive surface.

Finally, during a final filtering step 108, the touch localization computed in this way is placed in a circular buffer memory of fixed size. A first mean value is then computed on the set of values recorded in the buffer memory (after initializing same), and then updated after removing “outlier” values deemed to be too far from the mean. Adjustable thresholds (size of buffer memory and outlier value thresholds) are used to configure the filtering.

It clearly appears that a detection device including a capacitive sensor such as one of those described above, very readily adaptable to a large majority of touch-sensitive surfaces of all shapes and all materials, makes it possible to envisage the design of touch-sensitive surface touch localization devices which are both sensitive and inexpensive. The applications are multiple.

Firstly, a set of two, three, four (or more) detection devices including capacitive sensors such as those illustrated in FIGS. 1 and 2 may be provided, independently of any touch-sensitive surface, including an electronic signal processing module such as the electronic module 72 described above and wired or wireless means for transmitting signals from each of the detection devices to the electronic module. For a more compact design, the electronic module may be integrated in one of the detection devices of the set, said devices further having their own power source and capable of communicating with one another via radio or wired links. The set may be connected to a network or to a peripheral via a radio or wired link. A user is then free to render any surface touch-sensitive according to the user's needs or wishes: wooden board, window pane, frame, switches, etc.

As further described above, a possible application consists of rendering a table touch-sensitive, by inserting detection devices between this table and the tops of legs whereon it rests. It is then possible for example to control a television and/or handle the content thereof, particularly in “relative operating mode” of the localization device.

In the motor vehicle industry, the advantage of such technology is the possibility of creating three-dimensional interactive dashboards with an enhanced design, enabling clear identification of a driver's finger relative to the relief. In this way, the driver's attention is less focused on the command currently being carried out and remains focused on the road.

Finally, also in the motor vehicle industry, the localization device as illustrated in FIG. 4 may be used as a light-emitting diode strip extending on the passenger compartment ceiling from the front to the rear of the vehicle. When a user presses on the strip at a specific location, the closest diode lights up or is switched off.

It should be noted that for such applications in the motor vehicle industry, the compensation means 30 are particularly useful for compensating for the effects of vibrations which are frequent and non-negligible in vehicles. It may even be advantageous to envisage the use of accelerometers, as mentioned above. In this case, the compensation carried out by the accelerometers is performed directly on the raw data supplied by the detection devices.

It should also be noted that the technology proposed in this invention may prove to be complementary to other known technologies. In view of the derisory costs of the detection device proposed, it is indeed possible to envisage the combination thereof with technologies that are already mature so as to make up for the shortcomings thereof and enhance the robustness thereof and the reliability thereof. For example, it may be combined with technology consisting of placing an infrared frame around the touch-sensitive surface in order to enhance same in the event of an overly bright environment or with technology consisting of deploying a capacitive film.

It may also prove to be complementary to further promising technologies, such as that introduced into the patent FR 2 948 787 B1 which uses a learning set wherein the stability is highly sensitive to the temperature and to the fitting conditions.

It should further be noted that the invention is not limited to the embodiments described above. It will indeed be clear to those skilled in the art that various modifications may be made to the embodiments described above, in the light of the teaching described herein. In the claims hereinafter, the terms used should not be interpreted as limiting the claims to the embodiments disclosed in the present description, but should be interpreted to include therein any equivalents intended to be covered by the claims due to the wording thereof and which can be envisaged by those skilled in the art by applying general knowledge to the implementation of the teaching disclosed herein.

1-10. (canceled)

11. A mechanical stress detection device comprising:
a capacitive sensor including:
a first electrode including a first main face,
a second electrode including a second main face arranged facing the first main face of the first electrode,
an elastic dielectric medium extending between the first main face of the first electrode and the second main face of the second electrode; and
means for measuring a capacitance at terminals of the two electrodes;
means for compensating mechanical stress, wherein a fixed part is rigidly connected to one of the first and second electrodes and a movable part relative to the fixed part including an adjustable counterweight is rigidly connected to the other of the first and second electrodes.

12. The mechanical stress detection device according to claim 11, wherein the movable part is movable in rotation about a shaft of the fixed part and includes:
a first balance beam arm portion, wherein one end is configured to be in contact with a touch-sensitive surface, and
a second counterweight arm portion including the adjustable counterweight, the second arm portion extending on the other side of the shaft of the first part relative to the first arm portion.

13. The mechanical stress detection device according to claim 11, wherein the adjustable counterweight includes:
a rod wherein a part has a screw thread,
a mass attached to the rod by a helical link, and
a setting tip configured, by rotatably actuating the rod about the axis thereof, to move the mass along the rod to move the mass closer to or further from the shaft of the fixed part by sliding.

14. The mechanical stress detection device according to claim 13, wherein the setting tip includes a controlled motor.

15. The mechanical stress detection device according to claim 11, wherein the elastic dielectric material includes silicone or polyurethane.

16. The mechanical stress detection device according to claim 11, wherein the two electrodes are cylindrical, have circular cross-sections, and are arranged coaxially relative to one another, the two main faces facing one another being plane.

17. The mechanical stress detection device according to claim 11, further comprising means for estimating a stress applied against one of the two electrodes based on the capacitance measured.

18. A set of mechanical stress detection devices, comprising:
a plurality of mechanical stress detection devices according to claim 11;
an electronic module for processing signals from the plurality of detection devices; and
wired or wireless means for transmitting signals from each of the detection devices to the electronic signal processing module.

19. A device for localizing touch on a touch-sensitive surface comprising:
a set of mechanical detection devices according to claim 18;
a touch-sensitive surface against which the detection devices of the set are arranged, the movable parts of the compensation means thereof being in contact with the touch-sensitive surface; and
means for localizing touch on the touch-sensitive surface by processing, using the electronic module of the set, stresses estimated using the signals supplied by the detection devices.

20. The device for localizing touch according to claim 19, wherein the touch-sensitive surface includes a strip wherein activatable light sources are distributed linearly, the device further comprising:
one detection device arranged at each end of the strip; and
means for selecting a light source based on a touch localization.
